(19) United States
(12) Patent Application Publication
(10) Pub. No.: US 2026/0222871 A1
(43) Pub. Date: Jul. 30, 2026

(54) METHOD AND APPARATUS FOR INTEGRATED SENSING AND COMMUNICATION

(71) Applicant: LENOVO (BEIJING) LIMITED, Beijing (CN)

(72) Inventors: Luning Liu, Beijing (CN); Jianfeng Wang, Beijing (CN); Lianhai Wu, Beijing (CN); Haiming Wang, Beijing (CN); Zhi Yan, Beijing (CN)

(21) Appl. No.: 19/145,532

(22) PCT Filed: Jan. 6, 2023
(86) PCT No.: PCT/CN2023/070965

§ 371 Date: Jul. 3, 2025

(51) Int. Cl. H04W 24/10; H04W 8/24

(52) U.S. Cl. CPC H04W 24/10; H04W 8/24

(57) ABSTRACT

Embodiments of the present disclosure relate to a method and apparatus for integrated sensing and communication. According to some embodiments of the disclosure, a network node may transmit, via a BS, a first configuration associated with a sensing task to a first UE and a second configuration associated with the sensing task to a second UE, wherein the first configuration includes a sensing configuration for the first UE to perform the sensing task, and the second configuration is applied to the second UE after the second UE is activated to perform the sensing task; receive, from the first UE, a first measurement report based on the first configuration; and receive, from the second UE, a second measurement report based on the second configuration after the second UE is activated.

### TECHNICAL FIELD

Embodiments of the present disclosure generally relate to communication technology, and more particularly to integrated sensing and communication in a wireless communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Wireless sensing technologies aim to acquire information about a remote object and its characteristics without physically contacting it. Perception data of the object can be utilized for analysis, such that meaningful information about the object and its characteristics can be obtained. Radar is a widely used wireless sensing technology that uses radio waves to determine the distance (range), angle, or instantaneous linear velocity of objects. There are other sensing technologies including non-radio frequency (RF) sensors, which have been used in other areas, e.g., time-of-flight (ToF) cameras, accelerometers, gyroscopes and Lidars.

Integrated sensing and communication may refer to that the sensing capabilities are provided by the same wireless communication system and infrastructure (e.g., 5G NR) as used for communication, and the sensing information could be derived from RF-based and/or non-RF based sensors. In general, it could involve scenarios of communication assisted sensing, for example, where a communication system (e.g., 5G system) provides sensing services or sensing assisted communication, or when the sensing information related to the communication channel or environment is used to improve the communication service of the communication system itself, or the sensing information can be used to assist radio resource management, interference mitigation, beam management, mobility, etc.

Integrated sensing and communication can involve in different target verticals or applications, for example, autonomous/assisted driving, vehicle-to-everything (V2X), aviation/unmanned aerial vehicles (UAVs), 3D map reconstruction, smart city/factories, public sectors, healthcare, smart home, maritime sector, etc.

Therefore, it is desirable to introduce integrated sensing and communication into a wireless communication system such as a 5G system. It is further desirable to improve integrated sensing and communication services to satisfy various requirements under various application scenarios.

### SUMMARY

Some embodiments of the present disclosure provide a network node. The network node may include: a transceiver; and a processor coupled to the transceiver. The processor may be configured to: transmit, via a base station (BS), a first configuration associated with a sensing task to a first user equipment (UE) and a second configuration associated with the sensing task to a second UE, wherein the first configuration includes a sensing configuration for the first UE to perform the sensing task, and the second configuration is applied to the second UE after the second UE is activated to perform the sensing task; receive, from the first UE, a first measurement report based on the first configuration; and receive, from the second UE, a second measurement report based on the second configuration after the second UE is activated.

In some embodiments of the present disclosure, the processor may be further configured to transmit, to the BS, assistance data for activating a UE to perform the sensing task.

In some embodiments of the present disclosure, the assistance data includes at least one of the following: a threshold of receiving signal quality; an expected UE mobility state; a quality-of-service (QoS) requirement associated with the sensing task; or a list of UEs that can be activated to perform the sensing task.

In some embodiments of the present disclosure, the processor may be further configured to transmit a request to the BS based on the first measurement report, wherein the request indicates at least one of the following: an activation of at least one UE to perform the sensing task; or a deactivation of the first UE.

In some embodiments of the present disclosure, the request is transmitted in response to at least one of the following: the first measurement report indicates a measurement failure; or the sensing result associated with the first measurement report does not satisfy a requirement associated with the sensing task.

In some embodiments of the present disclosure, the processor may be further configured to receive, from the BS, a response in response to the request or in response to the third or fourth configuration, and the response includes at least one of the following: information of activated UEs; information of deactivated UEs; an indication of no available UE to be activated; information of candidate UEs to perform the sensing task; or a request for selecting a UE to perform the sensing task.

In some embodiments of the present disclosure, the processor may be further configured to perform at least one of the following in response to receiving the request for selecting a UE to perform the sensing task: select one or more UEs to perform the sensing task; transmit a sensing configuration to each of the one or more UEs; update a list of UEs that can be activated to perform the sensing task; or transmit a respective configuration to each UE in the list of UEs, wherein the respective configuration is applied to a corresponding UE in the list of UEs after the corresponding UE is activated to perform the sensing task.

In some embodiments of the present disclosure, the processor may be further configured to perform at least one of the following: transmit, to the first UE, a third configuration associated with a first condition for triggering an activation of the second UE; or transmit, to the BS, a fourth configuration associated with a second condition for triggering an activation of the second UE.

In some embodiments of the present disclosure, the first condition includes at least one of the following: a quality of a signal received by the first UE being lower than a threshold during a time window; or the first UE is leaving or leaves a target area associated with the sensing task.

In some embodiments of the present disclosure, the second condition includes a quality of a signal received by the BS being lower than a threshold during a time window.

In some embodiments of the present disclosure, the first configuration and the third configuration are transmitted to the first UE together or independently; or wherein the third configuration is transmitted to the first UE via dedicated signaling or system information (SI) broadcast.

Some embodiments of the present disclosure provide a UE. The UE may include: a transceiver; and a processor coupled to the transceiver. The processor may be configured to: receive, from a network node, a configuration associated with a sensing task, wherein the configuration is applied to the UE to perform the sensing task after an activation of the UE, or wherein the configuration is associated with a condition for triggering an activation of another UE to perform the sensing task; and transmit, to the network node, a measurement report based on the configuration.

In some embodiments of the present disclosure, the processor may be further configured to transmit assistance data to a base station (BS) in response to the condition being satisfied.

In some embodiments of the present disclosure, the assistance data indicates a measurement failure at the UE or that the UE is leaving or leaves a target area associated with the sensing task.

In some embodiments of the present disclosure, the configuration applied to the UE after the activation of the UE indicates at least one of the following: whether the UE acts as a transmitting or receiving node; a sensing mode of the UE; a sensing period of the UE; or radio resources for the UE to perform the sensing task.

Some embodiments of the present disclosure provide a BS. The BS may include: a transceiver; and a processor coupled to the transceiver. The processor may be configured to: receive, from a network node, first assistance data for activating a UE to perform a sensing task; activate a UE to perform the sensing task according to the first assistance data; and transmit a response to the network node in response to activating the UE.

In some embodiments of the present disclosure, the response includes at least one of the following: information of activated UEs; information of deactivated UEs; an indication of no available UE to be activated; information of candidate UEs to perform the sensing task; or a request for selecting a UE to perform the sensing task.

Some embodiments of the present disclosure provide a method performed by a network node. The method may include: transmitting, via a BS, a first configuration associated with a sensing task to a first UE and a second configuration associated with the sensing task to a second UE, wherein the first configuration includes a sensing configuration for the first UE to perform the sensing task, and the second configuration is applied to the second UE after the second UE is activated to perform the sensing task; receiving, from the first UE, a first measurement report based on the first configuration; and receiving, from the second UE, a second measurement report based on the second configuration after the second UE is activated.

Some embodiments of the present disclosure provide a method performed by a UE. The method may include: receiving, from a network node, a configuration associated with a sensing task, wherein the configuration is applied to the UE to perform the sensing task after an activation of the UE, or wherein the configuration is associated with a condition for triggering an activation of another UE to perform the sensing task; and transmitting, to the network node, a measurement report based on the configuration.

Some embodiments of the present disclosure provide a method performed by a BS. The method may include: receiving, from a network node, first assistance data for activating a UE to perform a sensing task; activating a UE to perform the sensing task according to the first assistance data; and transmitting a response to the network node in response to activating the UE.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present application provide a technical solution for integrated sensing and communication, which can facilitate and improve the implementation of various communication technologies.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure for UE positioning in accordance with some embodiments of the present disclosure;

FIGS. 3-7 illustrate flow charts of exemplary procedures for integrated sensing and communication in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

With the development of communication technologies, a sensing function or sensing ability is proposed to be introduced to the 3GPP. Embodiments of the present disclosure provide solutions for enabling and improving integrated sensing and communication in a communication system. For example, in some embodiments of the present disclosure, a sensing related service may be requested and issued to entities in a communication system. A UE may perform sensing in response to the request. Enhancements on the interface between the UE, BS, and network node may be needed to support the sensing function. Embodiments of the present disclosure provide signaling and procedures to enable and improve the integrated sensing and communication.

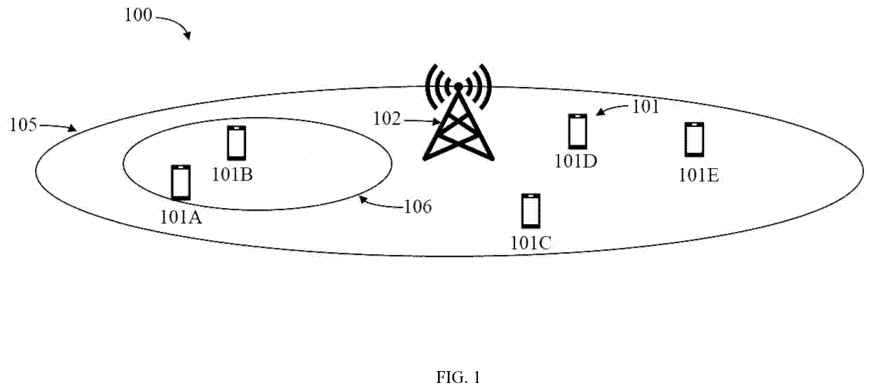

FIG. 1 illustrates a schematic diagram of wireless communication system 100 in accordance with some embodiments of the present disclosure.

As shown in FIG. 1, a wireless communication system 100 may include a base station (e.g., BS 102) and some UEs 101 (e.g., UEs 101A-101E) located within the coverage area 105 of BS 102. Although a specific number of UE 101 and BS 102 is depicted in FIG. 1, it is contemplated that any number of UEs and BSs may be included in the wireless communication system 100.

UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE 101 includes wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 101 may communicate with BS 102 via uplink (UL) communication signals.

BS 102 may be distributed over a geographic region. In certain embodiments of the present disclosure, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally a part of a radio access network that may include one or more controllers communicably coupled to one or more corresponding BSs 102. BS 102 may communicate with UE 101 via downlink (DL) communication signals.

BS 102 may be in communication with a core network (not shown in FIG. 1). The core network (CN) may include a plurality of network nodes, such as a mobility management entity (MME) (not shown in FIG. 1) or an access and mobility management function (AMF) (not shown in FIG. 1). The CN may serve as gateways for the UEs to access a public switched telephone network (PSTN) and/or other networks (not shown in FIG. 1). In some embodiments of the present disclosure, the CN may further include a sensing function (SF) which may be in communication with, for example, the AMF, location management function (LMF), or the like.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 102 and UE 101 may communicate using other communication protocols, such as the IEEE 802.11 family of wireless communication protocols. Further, in some embodiments of the present disclosure, BS 102 and UE 101 may communicate over licensed spectrums, whereas in some other embodiments, BS 102 and UE 101 may communicate over unlicensed spectrums. The present disclosure is not intended to be limited to the implementation of any particular wireless communication system architecture or protocol.

In some embodiments of the present disclosure, typical scenarios for integrated sensing and communication (ISAC) may include “per-object sensing” and “per-area sensing.” For example, referring to FIG. 1, BS 102 may want to sense a target (e.g., UE 101B) in the scenario of “per-object sensing.” For example, BS 102 may want to acquire the position or speed of UE 101B. For example, in the scenario of “per-area sensing,” sensing nodes may need to efficiently sense the real-time status of roads, vehicles, and people in factories, roads, cities, and even larger spatiotemporal ranges. For example, referring to FIG. 1, BS 102 and UEs 101A and 101B within sensing area 106 may perform a sensing task associated with sensing area 106.

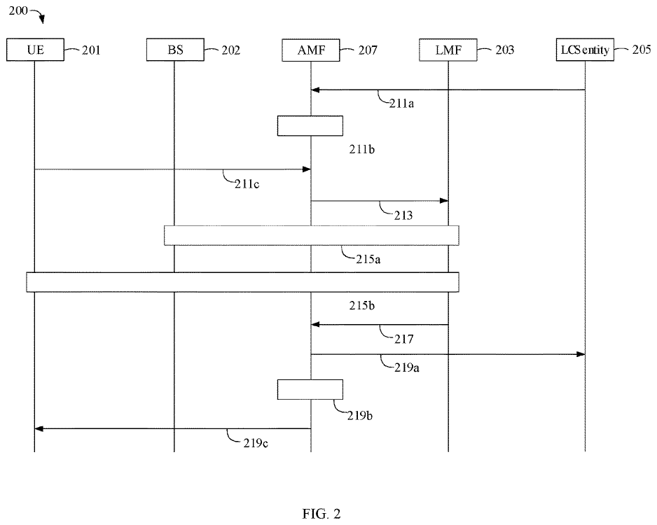

Location service or positioning is an exemplary ISAC application. FIG. 2 illustrates a flow chart of exemplary procedure 200 for UE positioning in accordance with some embodiments of the present disclosure. Details described in all of the foregoing embodiments of the present disclosure are applicable for the embodiments shown in FIG. 2.

Referring to FIG. 2, UE 201 and BS 202 may function as UE 101 and BS 102 shown in FIG. 1, respectively. AMF 207 may be in (direct or indirect) communication with location management function (LMF) 203 and location service (LCS) entity 205.

In some embodiments of the present disclosure, various entities may trigger a location service. For example, in some examples, in operation 211a, a CN entity such as LCS entity 205 (e.g., gateway mobile location service (GMLC)) may request a location service (e.g., positioning) for a target UE (e.g., UE 201) to AMF 207 (i.e., the serving AMF). For example, in some examples, in operation 211b, AMF 207 (i.e., the serving AMF) for a target UE (e.g., UE 201) may determine the need for a location service (e.g., to locate the UE for an emergency call). For example, in some examples, in operation 211c, UE 201 may request a location service (e.g., positioning or delivery of assistance data) to AMF 207 (i.e., the serving AMF) at the non-access stratum (NAS) level.

In operation 213, AMF 207 may transfer the location service request to an LMF 203. In operation 215a, AMF 207 may instigate location procedures with the serving and possibly neighboring BS (e.g., ng-eNB or gNB in the next generation radio access network (NG-RAN)), for example, to obtain positioning measurements or assistance data. In some embodiments, in addition to operation 215a or instead of operation 215a, LMF 203 may, in operation 215b, instigate location procedures with UE 201, for example, to obtain a location estimate or positioning measurements or to transfer location assistance data to UE 201.

In operation 217, LMF 203 may provide a location service response to AMF 207 and include any needed results including, for example, a success or failure indication and (if requested and obtained) a location estimate for UE 201.

In the case that operation 211a was performed, AMF 207 may, in operation 219a, return a location service response to LCS entity 205 and include any needed results including, for example, a location estimate for UE 201.

In the case that operation 211b was performed, AMF 207 may, in operation 219b, use the location service response received in operation 217 to assist the service that triggered operation 211b (for example, may provide a location estimate associated with an emergency call to a GMLC).

In the case that operation 211c was performed, AMF 207 may, in operation 219c, return a location service response to UE 201 and include any needed results including, for example, a location estimate for UE 201.

It should be appreciated by persons skilled in the art that the sequence of the operations in exemplary procedure 200 may be changed and some of the operations in exemplary procedure 200 may be eliminated or modified, without departing from the spirit and scope of the disclosure.

Although embodiments of the present disclosure are described with respect to network nodes such as the AMF, LMF, and LCS entity, it is contemplated that other network nodes may be employed to perform the operations of the AMF, LMF, and LCS entity.

In some scenarios (e.g., in the per-area sensing scenario), some ISAC applications (e.g., high-definition map generation) may be sensitive to delay and require high sensing accuracy. This would require a group of sensing nodes (e.g., sensing UEs) in a large area to participate in the tasks. However, ensuring a pool of sensing nodes (e.g., sensing UEs) available may be challenging in these scenarios (e.g., the per-area sensing scenario) due to the uncertain mobility of the sensing nodes (e.g., UEs such as smart vehicles), which may degrade sensing quality significantly. Further considering that these ISAC applications may be very relevant to people's production and life safety, it would be imperative to guarantee sensing quality and satisfy the (high) requirements of the ISAC service(s) with uncertain mobility of the sensing nodes (e.g., sensing UEs).

Embodiments of the present disclosure provide solutions for ISAC, which can at least handling the above issues. For example, solutions for guaranteeing the service requirements (e.g., strict latency and sensing accuracy requirements, and quality of service (QoS) requirement of an ISAC service) when the candidate sensing nodes (e.g., sensing UEs) in the sensing area have uncertain mobility are proposed. More details on the embodiments of the present disclosure will be illustrated in the following text in combination with the appended drawings.

In some embodiments of the present disclosure, sensing nodes (e.g., sensing UEs) and alternate nodes (e.g., alternate UEs) may be designated (e.g., by a network node such as SF) according to the information of UE capability and requirement(s) of the ISAC service. A sensing UE refers to a UE conducting a sensing task and an alternate UE refers to a UE that only perform a sensing task after activation. According to the measurement reports from the sensing UE(s) or the BS(s), the SF may determine or select which cell(s) need to activate alternate UEs and transmit an activation request to the selected BS(s). In response to receiving the request, the BS may determine which alternate UE(s) needs to be activated based on, for example, the latest status of the UEs (e.g., signal quality, mobility information).

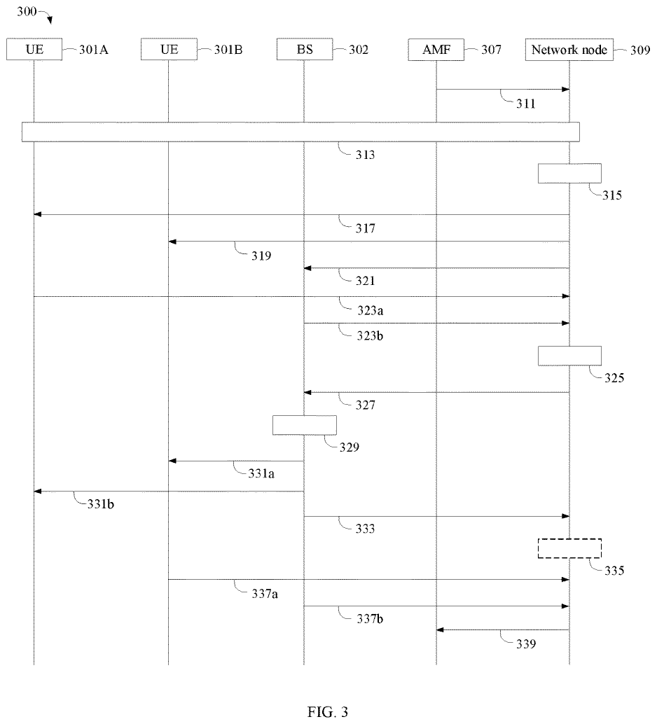

FIG. 3 illustrates a flow chart of exemplary procedure 300 for integrated sensing and communication in accordance with some embodiments of the present disclosure. Details described in all of the foregoing embodiments of the present disclosure are applicable for the embodiments shown in FIG. 3.

Referring to FIG. 3, UE 301A and UE 301B may function as the UEs shown in FIGS. 1 and 2, BS 302 may function as the BSs shown in FIGS. 1 and 2, and AMF 307 may function as AMF 207 shown in FIG. 2. AMF 307 may be in communication with network node 309 (e.g., an SF) and BS 302.

Network node 309 may receive a request for a sensing task (e.g., an ISAC service request). For example, in operation 311, AMF 307 may transmit an ISAC service request to network node 309. In some embodiments, the request may include at least one of the following: strict latency and sensing accuracy requirements; a target sensing area; a sensing result type; or information of candidate nodes for performing the sensing task (e.g., candidate sensing UEs information).

In operation 313, network node 309 may obtain the capabilities of candidate sensing UEs (e.g., the specific sensing methods or sensing modes that a UE supports, UE calculation ability, etc.), UE mobility and location information, etc.

In some embodiments, a sensing mode may refer to a transmitting and/or receiving mode, including, for example, a UE transmits a signal to another UE, a UE transmits a signal to the UE per se, a UE transmits a signal to a BS, a BS transmits a signal to a UE, a BS transmits a signal to the BS per se, or a BS transmits a signal to another BS. In some embodiments, UE mobility may refer to the speed information of a UE, such as whether the speed of the UE is high, medium, or low, which can be inferred by a computing module (e.g., a navigation system) in some scenarios.

In operation 315, network node 309 may select UEs for performing the sensing task (hereinafter referred to as “sensing UEs” for clarity) and alternate UEs based on, for example, the information obtained in operation 313. An alternative UE may refer to a UE that needs to be activated before performing the sensing task. For example, network node 309 may select UE 301A as a sensing UE and UE 301B as an alternative UE.

Various selection strategies may be employed by network node 309. For example, UEs which are sufficiently close to the target sensing area or UEs around the sensing area (e.g., the distance between a UE and the target sensing area is smaller than a certain threshold) can be selected. For example, network node 309 may sort the candidate UEs according to certain criteria. For example, the candidate UEs can be sorted according to the degrees to which the UE trajectories coincide with the target sensing area (i.e., it can suggest how much time a UE can stay in the sensing area). For example, the candidate UEs can be sorted according to UE capability information, for example, the specific sensing methods or sensing mode that a UE supports. Network node 309 may then select a number of sensing UEs (e.g., L sensing UEs) and a number of alternate UEs (e.g., R alternate UEs) in sequence. In some examples, the value of L can be given by the request for the sensing task or determined by network node 309 according to, for example, the requirement specified in the request for the sensing task. In some examples, the value of R can be determined by network node 309 according to, for example, the requirement specified in the request for the sensing task.

In operation 317, network node 309 may transmit a configuration (denoted as “configuration #1” for clarity) associated with the sensing task to UE 301A. Configuration #1 may be transmitted to a sensing UE such as UE 301A via the corresponding serving BS. In the context of the present disclosure, the transmission from a network node to a UE (e.g., a sensing UE or an alternate UE) or the transmission from a UE (e.g., a sensing UE or an alternate UE) to a network node may be a transparent transmission. For example, the BS simply passes through the configuration from the network node to a sensing UE without changing, parsing or decoding the signaling or data. In some other examples, the transmission may not be a transparent transmission.

In some embodiments, configuration #1 may be delivered to a sensing UE such as UE 301A by dedicated signaling or system information (SI) broadcast.

In some embodiments, configuration #1 may include a sensing configuration for a sensing UE (e.g., UE 301A) to perform the sensing task. For example, configuration #1 may indicate at least one of the following: a transmitting or receiving role (e.g., whether UE 301A acts as a transmitting or receiving node); a sensing mode (e.g., a sensing mode that UE 301A employs when performing the sensing); a sensing period (e.g., a sensing period that UE 301A employs when performing the sensing); or information to configure radio resources for the sensing (e.g., configuring radio resources for UE 301A to perform the sensing task).

In operation 319, network node 309 may transmit a configuration (denoted as “configuration #2” for clarity) associated with the sensing task to UE 301B. Configuration #2 may be used after activation (e.g., after UE 301B is activated to perform the sensing task). Configuration #2 may be transmitted to an alternate UE such as UE 301B via the corresponding serving BS. In some examples, the transmission may be a transparent transmission. In some other examples, the communications may not be a transparent transmission.

In some embodiments, configuration #2 may be delivered to an alternate UE such as UE 301B by dedicated signaling or SI broadcast. In some embodiments, configuration #2 may indicate at least one of the following: a transmitting or receiving role (e.g., whether UE 301B acts as a transmitting or receiving node); a sensing mode (e.g., a sensing mode that UE 301B employs when performing the sensing); a sensing period (e.g., a sensing period that UE 301B employs when performing the sensing); or information to configure radio resources for the sensing (e.g., configuring radio resources for UE 301B to perform the sensing task).

Network node 309 may transmit assistance data to the serving BS(s) of the alternate UE(s). The assistance data can be used for activating the alternate UE(s) to perform the sensing task. For example, in operation 321, network node 309 may transmit assistance data to the serving BS (e.g., BS 302) of UE 301B. The assistance data can be used for activating UE 301B to perform the sensing task.

In some embodiments, the assistance data may include at least one of the following: a threshold of receiving signal quality; an expected UE mobility state; a QoS requirement associated with the sensing task; or a list of UEs that can be activated to perform the sensing task (e.g., a list of alternate UEs). For example, the threshold may be used by BS 302 to select alternate UEs in the coverage of BS 302. For example, the expected UE mobility state may include expected UE speed, location information or both. For example, an alternate UE with a relatively low speed and/or close enough to the sensing area can be selected. For example, the QoS requirement refers to the QoS requirement of the expected sensing service for BS 302 to conduct the necessary radio resources.

In some embodiments, according to the specific sensing methods or sensing modes (e.g., PC5 or Uu, DL or UL, or DL plus UL), a sensing UE, a BS, or both may transmit a measurement report to network node 309. The measurement report may be based on the corresponding configuration (e.g., configuration #1). For example, in operation 323a, UE 301A may transmit a measurement report based on configuration #1 to network node 309. For example, in addition to operation 323a or instead of operation 323a, BS 302 may, in operation 323b, transmit a measurement report to network node 309. The measurement report reported by BS 302 may be based on a configuration associated with the sensing task configured for BS 302 by network node 309. In some examples, the configuration for BS 302 and configuration #1 may be related to each other. In some examples, the configuration for BS 302 may influence the measurement report reported by UE 301A. In some examples, configuration #1 may influence the measurement report reported by BS 302.

In some embodiments, according to the received measurement report, network node 309 may, in operation 325, determine one or more cells in the sensing area which needs to: activate alternate UEs, deactivate sensing UEs or both. The determination may be based on at least one of the following cases: the measurement report indicates a measurement failure (e.g., a failure cause in the measurement report); or the sensing result associated with the measurement report (e.g., the sensing result calculated by the measurement report) does not satisfy a requirement associated with the sensing task.

For example, based on the measurement report received in operation 323a, operation 323b, or both, network node 309 may determine that BS 302 needs to: activate at least one alternate UE, deactivate at least one sensing UE (e.g., UE 301A) or both. In operation 327, network node 309 may transmit a request to BS 302 (i.e., a BS which needs to activate alternate UEs and/or de-activate sensing UEs). The request may indicate at least one of the following: an activation of at least one alternate UE (e.g., UE 301B) to perform the sensing task; or a deactivation of at least one sensing UE (e.g., UE 301A). In some examples, the request may also include some assistance information, such as the number of alternate UEs that need to be activated, and/or a list of sensing UEs to be deactivated.

In response to receiving an activation request (e.g., the request in operation 327 indicates an activation of at least one alternate UE), BS 302 may determine one or more alternate UEs to be activated in operation 329. For example, the determination may be based on the assistance data from network node 309. For example, the determination may be based on at least one of the quality of the link between BS 302 and an alternate UE (e.g., reference signal received power (RSRP) of an indicated signal such as a channel state information reference signal (CSI-RS)) or a mobility state of an alternate UE (e.g., the speed of an alternate UE such as high, medium, or low speed). For example, BS 302 may determine to activate UE 301B. In operation 331a, BS 302 may transmit an activation message to UE 301B. The activation message may be transmitted via lower layer (e.g., layer 1 (L1) or layer 2 (L2)) signaling or high layer (e.g., RRC) signaling. In some embodiments, when, for example, there is no available alternate UE (e.g., the alternate UEs have left the cell of the BS), operation 331a may be omitted.

In response to receiving a deactivation request (e.g., the request in operation 327 indicates a deactivation of at least one sensing UE), BS 302 may transmit a deactivation message to a sensing UE. The sensing UE to be deactivated may be designated by network node 309. For example, in operation 331b, BS 302 may transmit a deactivation message to UE 301A. The deactivation message may be transmitted via lower layer (e.g., L1 or L2) signaling or high layer (e.g., RRC) signaling.

In operation 333, BS 302 may inform network node 309 corresponding information about the deactivation and/or activation of a UE. Or put another way, BS 302 may transmit a response to network node 309 in response to the request received from network node 309 in operation 327, the activation of an alternate UE (e.g., UE 301B), or the deactivation of a sensing UE (e.g., UE 301A).

In some embodiments, such response may include at least one of the following: information of activated UEs; information of deactivated UEs; an indication of no available UE to be activated; information of candidate UEs to perform the sensing task; or a request for selecting a UE to perform the sensing task.

For example, when BS 302 has deactivated one or more sensing UEs, BS 302 may include the information of deactivated sensing UEs in the response. When there are available alternate UEs and BS 302 has activated one or more alternate UEs, BS 302 may include the information of activated alternate UEs in the response. When there is no available alternate UE, BS 302 may include an indication of no available alternate UE in the response. BS 302 may further include the information of candidate sensing UEs, a request for selecting sensing UEs, or both in the response.

In some embodiments, when the request for selecting sensing UEs is included in the response, network node 309 may select one or more sensing UEs in operation 335 (denoted by a dotted block as an option). Network node 309 may transmit sensing configurations (e.g., configuration #1) to the selected sensing UEs. Network node 309 may also update the list of alternate UEs for performing the sensing task. Network node 309 may transmit a corresponding configuration (e.g., configuration #2) to each alternate UE in the updated list or to each new alternate UE in the updated list. The corresponding configuration can be applied after the corresponding alternate UE is activated to perform the sensing task.

Similar to operations 323a and 323b, network node 309 may receive a measurement report from the activated alternate UE, the BS, or both. The measurement report may be based on configuration #2. For example, in response to activating UE 301B in operation 331a, UE 301B may, in operation 337a, transmit a measurement report based on configuration #2 received in operation 319 to network node 309. For example, in addition to operation 337a or instead of operation 337a, BS 302 may, in operation 337b, transmit a measurement report to network node 309. The measurement report reported by BS 302 may be based on a configuration associated with the sensing task configured for BS 302 by network node 309. In some examples, the configuration for BS 302 and configuration #2 may be related to each other. In some examples, the configuration for BS 302 may influence the measurement report reported by UE 301B. In some examples, configuration #2 may influence the measurement report reported by BS 302.

It should be noted that the existing sensing UEs (e.g., the sensing UEs which are not deactivated) may continue to perform the sensing task and transmit the measurement report according to, for example, the sensing configurations, after the activation of the alternate UEs (e.g., UE 301B).

In operation 339, network node 309 may transmit the result of the ISAC service request to AMF 307 (i.e., the entity which initiates the request). The result may be based on the received measurement reports.

It should be appreciated by persons skilled in the art that the sequence of the operations in exemplary procedure 300 may be changed and some of the operations in exemplary procedure 300 may be eliminated or modified, without departing from the spirit and scope of the disclosure.

The above exemplary procedure activates alternate UEs after receiving the measurement report(s), which may result in a relatively long delay. Embodiments of the present disclosure further provide enhanced solutions for ISAC, which can further reduce such delay. For example, by configuring appropriate conditions for sensing UEs or BSs, the activation process of alternate UEs can be accelerated. For example, a network node (e.g., an SF) may configure conditions for sensing UEs, BSs, or both. After a condition is satisfied, a sensing UE may transmit assistance information to the BS, which can be used to trigger alternate UE activation. After a condition is satisfied, the BS can trigger alternate UE activation.

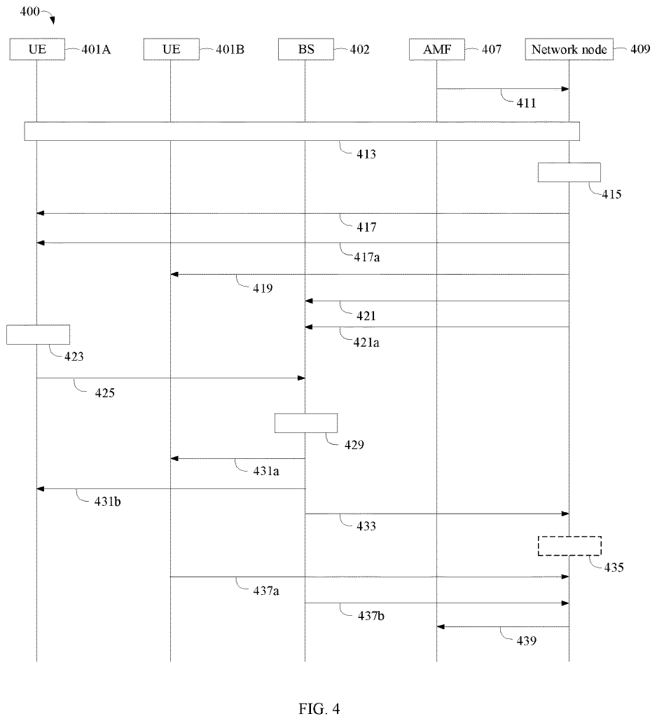

FIG. 4 illustrates a flow chart of exemplary procedure 400 for integrated sensing and communication in accordance with some embodiments of the present disclosure. Details described in all of the foregoing embodiments of the present disclosure are applicable for the embodiments shown in FIG. 4.

Referring to FIG. 4, UE 401A, UE 401B, BS 402, AMF 407, and network node 409 may function as the UEs, BSs, AMFs, and network nodes (or SFs) shown in previous figures. AMF 407 may be in communication with network node 409 (e.g., an SF) and BS 402.

Network node 409 may receive a request for a sensing task (e.g., an ISAC service request). Operations 411-417 may be similarly performed as operations 311-317 in FIG. 3. For example, in operation 411, AMF 407 may transmit an ISAC service request to network node 409. In some embodiments, the request may include at least one of the following: strict latency and sensing accuracy requirements; a target sensing area; a sensing result type; or information of candidate nodes for performing the sensing task (e.g., candidate sensing UEs information).

In operation 413, network node 409 may obtain the capabilities of candidate sensing UEs (e.g., the specific sensing methods or sensing modes that a UE supports, UE calculation ability, etc.), UE mobility and location information, etc. The aforementioned descriptions of the sensing mode and UE mobility may also apply here and thus are omitted herein.

In operation 415, network node 409 may select UEs for performing the sensing task (hereinafter referred to as “sensing UEs” for clarity) and alternate UEs based on, for example, the information obtained in operation 413. An alternative UE may refer to a UE that needs to be activated before performing the sensing task. For example, network node 409 may select UE 401A as a sensing UE and UE 401B as an alternative UE.

Various selection strategies may be employed by network node 409. For example, the aforementioned selection strategies may also apply here. For example, UEs which are sufficiently close to the target sensing area or UEs around the sensing area can be selected.

In operation 417, network node 409 may transmit a configuration (denoted as “configuration #1′” for clarity) associated with the sensing task to UE 401A. Configuration #1′ may be transmitted to a sensing UE such as UE 401A via the corresponding serving BS. The transmission may or may not be a transparent transmission.

The aforementioned descriptions regarding configuration #1 may be applied to configuration #1′. For example, configuration #1′ may be delivered to a sensing UE such as UE 401A by dedicated signaling or system information (SI) broadcast. For example, configuration #1′ may include information to configure radio resources for the sensing (e.g., configuring radio resources for UE 401A to perform the sensing task).

In operation 419, network node 409 may transmit a configuration (denoted as “configuration #2” for clarity) associated with the sensing task to UE 401B. Configuration #2′ may be used after activation (e.g., after UE 401B is activated to perform the sensing task). Configuration #2′ may be transmitted to an alternate UE such as UE 401B via the corresponding serving BS. The transmission may or may not be a transparent transmission. The aforementioned descriptions regarding configuration #2 may be applied to configuration #2′.

Network node 409 may transmit assistance data (denoted as “assistance data #1” for clarity) to the serving BS(s) of the alternate UE(s). Assistance data #1 can be used for activating the alternate UE(s) to perform the sensing task. For example, in operation 421, network node 409 may transmit assistance data #1 to the serving BS (e.g., BS 402) of UE 401B, which can be used for activating UE 401B to perform the sensing task.

The aforementioned descriptions regarding the assistance data (e.g., the assistance data described with respect to operation 321) may be applied to assistance data #1. For example, assistance data #1 may include at least one of the following: a threshold of receiving signal quality; an expected UE mobility state; a QoS requirement associated with the sensing task; or a list of alternate UEs. For example, the threshold may be used by BS 402 to select alternate UEs in the coverage of BS 402. For example, the expected UE mobility state may include expected UE speed, location information or both. For example, an alternate UE with a relatively low speed and/or close enough to the sensing area can be selected. For example, the QoS requirement refers to the QoS requirement of the expected sensing service for BS 402 to conduct the necessary radio resources.

In some embodiments, to advance the activation of alternate UEs, network node 409 may transmit an additional configuration to UE 401A, BS 402, or both. For example, network node 409 may configure one or more conditions to trigger the activation of alternate UEs.

In some embodiments, network node 409 may, in operation 417a, transmit to UE 401A a configuration (denoted as “configuration #3” for clarity) associated with a condition (denoted as “condition #1” for clarity) for triggering an activation of an alternate UE (e.g., UE 401B).

In some embodiments, condition #1 may include at least one of the following: the quality of a signal (e.g., RSRP) received by UE 401A (i.e., sensing UE) being lower than a threshold during a time window; or UE 401A (i.e., sensing UE) is leaving or leaves the current sensing area (i.e., the target area associated with the sensing task). The mobility of a sensing UE or sensing object may cause signal quality degradation. Configuration #3 may, for example, indicate the threshold for the received signal quality.

In some embodiments, configuration #3 may be transmitted to UE 401A via dedicated signaling or SI broadcast. In some embodiments, configuration #3 may be transmitted to UE 401A with configuration #1′. For example, configuration #1′ and configuration #3 are transmitted to UE 401A using the same signaling or message. Operation 417 and operation 417a may thus be merged into one operation. In some embodiments, configuration #3 and configuration #1′ may be transmitted independently, for example, using different signaling or messages. Operation 417 and operation 417a may thus be performed separately.

In response to receiving configuration #3, UE 401A may, in operation 423, determine whether condition #1 is satisfied. In response to condition #1 (e.g., one of at least one configured condition) being satisfied, UE 401A may transmit assistance data (denoted as “assistance data #2” for clarity) to BS 402 in operation 425. Assistance data #2 may trigger an activation of an alternate UE, a deactivation of a sensing UE, or both. Assistance data #2 may indicate a measurement failure at UE 401A or that UE 401A is leaving or leaves the target area associated with the sensing task.

For example, when the quality of the signal received by UE 401A is lower than the configured threshold during a certain time window, assistance data #2 may indicate a measurement failure. For example, when UE 401A is leaving or leaves a target area associated with the sensing task, assistance data #2 may indicate the mobility information of UE 401A (e.g., UE 401A is leaving or leaves the current sensing area such that UE 401A cannot the conduct the sensing task).

In some embodiments, network node 409 may, in operation 421a, transmit to BS 402, a configuration (denoted as “configuration #4” for clarity) associated with a condition (denoted as “condition #2” for clarity) for triggering an activation of an alternate UE (e.g., UE 401B).

In some embodiments, condition #2 may include: the quality of a signal (e.g., RSRP) received by BS 402 being lower than a threshold during a time window. Configuration #4 may, for example, indicate the threshold for the received signal quality.

In some embodiments, configuration #4 may be transmitted to BS 402 with assistance data #1. For example, assistance data #1 and configuration #4 are transmitted to BS 402 using the same signaling or message. Operation 421 and operation 421a may thus be merged into one operation. In some embodiments, configuration #4 and assistance data #1 may be transmitted independently, for example, using different signaling or messages. Operation 421 and operation 421a may thus be performed separately.

In response to receiving configuration #4, BS 402 may determine whether condition #2 is satisfied. In response to condition #2 (e.g., one of at least one configured condition) being satisfied, receiving assistance data #2, or both, BS 402 may perform at least one of the following: transmitting a deactivation message to a sensing UE associated with the condition being satisfied; determining an alternative UE(s) to be activated; or transmitting an activation message to the determined UE(s). The deactivation or activation message may be transmitted via lower layer (e.g., L1 or L2) signaling or high layer (e.g., RRC) signaling.

For example, BS 402 may determine that the quality of a signal between UE 401A (i.e., sensing UE) and BS 402 being lower than the configured threshold during a certain time window. BS 402 may then, in operation 431b, transmit a deactivation message to UE 401A in response to the determination. For example, BS 402 may receive assistance data #2 from UE 401A (i.e., sensing UE). BS 402 may then, in operation 431b, transmit a deactivation message to UE 401A in response to the received assistance data #2.

For example, in response to the determination, the received assistance data #2, or both, BS 402 may, in operation 429, determine to activate one or more alternate UEs according to assistance data #1. For example, the determination may be based on assistance data #1 from network node 409. For example, the determination may be based on at least one of the quality of the link between BS 402 and an alternate UE (e.g., RSRP of an indicated signal such as a CSI-RS) or a mobility state of an alternate UE (e.g., the speed of an alternate UE such as high, medium, or low speed).

For example, BS 402 may determine to activate UE 401B. In operation 431a, BS 402 may transmit an activation message to UE 401B to activate UE 401B to perform the sensing task according to assistance data #1. In some embodiments, when, for example, there is no available alternate UE (e.g., the alternate UEs have left the cell of the BS), operation 431a may be omitted.

In operation 433, BS 402 may inform network node 409 corresponding information about the deactivation and/or activation of a UE. Or put another way, BS 402 may transmit a response to network node 409 in response to the activation of an alternate UE (e.g., UE 401B) and/or the deactivation of a sensing UE (e.g., UE 401A).

In some embodiments, such response may include at least one of the following: information of activated UEs; information of deactivated UEs; an indication of no available UE to be activated; information of candidate UEs to perform the sensing task; or a request for selecting a UE to perform the sensing task.

For example, when BS 402 has deactivated one or more sensing UEs, BS 402 may include the information of deactivated sensing UEs in the response. When there are available alternate UEs and BS 402 has activated one or more alternate UEs, BS 402 may include the information of activated alternate UEs in the response. When there is no available alternate UE, BS 402 may include an indication of no available alternate UE in the response. BS 402 may further include the information of candidate sensing UEs, a request for selecting sensing UEs, or both in the response.

In some embodiments, when the request for selecting sensing UEs is included in the response, network node 409 may select one or more sensing UEs in operation 435 (denoted by a dotted block as an option). Network node 409 may transmit sensing configurations (e.g., configuration #1′) to the selected sensing UEs. Network node 409 may also update the list of alternate UEs for performing the sensing task. Network node 409 may transmit a corresponding configuration (e.g., configuration #2′) to each alternate UE in the updated list or to each new alternate UE in the updated list. The corresponding configuration can be applied after the corresponding alternate UE is activated to perform the sensing task.

Network node 409 may receive a measurement report from the activated alternate UE (which is also a sensing UE), the BS, or any combination thereof. For example, in response to activating UE 401B in operation 431a, UE 401B may, in operation 437a, transmit a measurement report based on configuration #2′ to network node 409. For example, in addition to operation 437a or instead of operation 437a, BS 402 may, in operation 437b, transmit a measurement report to network node 409. The measurement report reported by BS 402 may be based on a configuration associated with the sensing task configured for BS 402 by network node 409. In some examples, the configuration for BS 402 and configuration #2′ may be related to each other. In some examples, the configuration for BS 402 may influence the measurement report reported by UE 401B. In some examples, configuration #2′ may influence the measurement report reported by BS 402.

It should be noted that the existing sensing UEs (e.g., the sensing UEs which are not deactivated) may continue to perform the sensing task and transmit the measurement report according to, for example, the sensing configurations, after the activation of the alternate UEs (e.g., UE 401B).

In operation 439, network node 409 may transmit the result of the ISAC service request to AMF 407 (i.e., the entity which initiates the request). The result may be based on the received measurement reports.

It should be appreciated by persons skilled in the art that the sequence of the operations in exemplary procedure 400 may be changed and some of the operations in exemplary procedure 400 may be eliminated or modified, without departing from the spirit and scope of the disclosure.

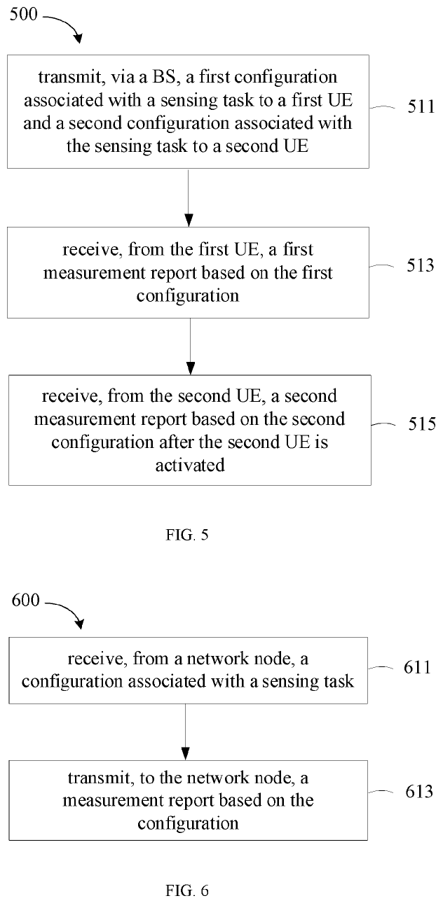

FIG. 5 illustrates a flow chart of exemplary procedure 500 for integrated sensing and communication in accordance with some embodiments of the present disclosure. Details described in all of the foregoing embodiments of the present disclosure are applicable for the embodiments shown in FIG. 5. In some examples, the procedure may be performed by a network node (e.g., an SF).

Referring to FIG. 5, in operation 511, a network node may transmit, via a BS, a configuration (denoted as “first configuration” for clarity) associated with a sensing task to a UE (denoted as “first UE” for clarity) and another configuration (denoted as “second configuration” for clarity) associated with the sensing task to another UE (denoted as “second UE” for clarity). The first UE can be a sensing UE, and the second UE can be an alternate UE. In some embodiments of the present disclosure, the first configuration may include a sensing configuration for the first UE to perform the sensing task, and the second configuration may be applied to the second UE after the second UE is activated to perform the sensing task.

In operation 513, the network node may receive, from the first UE, a measurement report (denoted as “first measurement report” for clarity) based on the first configuration. In operation 515, the network node may receive, from the second UE, a measurement report (denoted as “second measurement report” for clarity) based on the second configuration after the second UE is activated. It should be noted that as stated in the foregoing embodiments, the BS may transmit a measurement report to the network node in some embodiments.

In some embodiments of the present disclosure, the second configuration may indicate at least one of the following: whether the second UE acts as a transmitting or receiving node; a sensing mode of the second UE; a sensing period of the second UE; or radio resources for the second UE to perform the sensing task. In some embodiments of the present disclosure, the second configuration may be transmitted to the second UE via dedicated signaling or SI broadcast.

In some embodiments of the present disclosure, the network node may transmit, to the BS, assistance data for activating a UE to perform the sensing task. In some embodiments of the present disclosure, the assistance data may include at least one of the following: a threshold of receiving signal quality; an expected UE mobility state; a QoS requirement associated with the sensing task; or a list of UEs (e.g., a list of alternate UEs) that can be activated to perform the sensing task. The assistance data may assist the BS to select UEs (e.g., to select alternate UEs to be activated) to perform the sensing task.

For example, the threshold may be used by the BS to select UEs (e.g., alternate UEs) in the coverage of the BS. When the receiving signal quality between the BS and a UE is greater than or equal to the threshold, the UE can be selected. For example, the expected UE mobility state may include expected UE speed, location information or both. For example, a UE (e.g., an alternate UE) with a relatively low speed and close enough to the sensing area can be selected. For example, the QoS requirement refers to the QoS requirement of the expected sensing service for the BS to conduct the necessary radio resources.

In some embodiments of the present disclosure, the network node may transmit a request to the BS based on the first measurement report. In some embodiments, the request may indicate at least one of the following: an activation of at least one UE to perform the sensing task; or a deactivation of the first UE. In some embodiments, the request may include some necessary assistance information, such as the number of UEs (e.g., alternate UEs) that need to be activated, a list of UEs (e.g., sensing UEs) to be de-activated, etc.

In some embodiments of the present disclosure, the request may be transmitted in response to at least one of the following: the first measurement report indicates a measurement failure; or the sensing result associated with the first measurement report does not satisfy a requirement associated with the sensing task.

In some embodiments of the present disclosure, the network node may perform at least one of the following: transmit, to the first UE, a configuration (denoted as “third configuration” for clarity) associated with a condition (denoted as “first condition” for clarity) for triggering an activation of an alternate UE (e.g., the second UE); or transmit, to the BS, a configuration (denoted as “fourth configuration” for clarity) associated with a condition (denoted as “second condition” for clarity) for triggering an activation of an alternate UE (e.g., the second UE).

In some embodiments of the present disclosure, the first condition may include at least one of the following: a quality of a signal received by the first UE being lower than a threshold during a time window; or the first UE is leaving or leaves a target area associated with the sensing task. In some embodiments, the third configuration may indicate the threshold.

In some embodiments of the present disclosure, the second condition may include a quality of a signal received by the BS being lower than a threshold during a time window. In some embodiments, the fourth configuration may indicate the threshold.

In some embodiments of the present disclosure, the first configuration and the third configuration may be transmitted to the first UE together or independently, for example, in the same or separate signaling. In some embodiments of the present disclosure, the third configuration may be transmitted to the first UE via dedicated signaling or SI broadcast.

In some embodiments of the present disclosure, the network node may receive, from the BS, a response in response to the request or in response to the third or fourth configuration. The response may include at least one of the following: information of activated UEs; information of deactivated UEs; an indication of no available UE to be activated; information of candidate UEs to perform the sensing task; or a request for selecting a UE to perform the sensing task.

In some embodiments of the present disclosure, the network node may perform at least one of the following in response to receiving the request for selecting a UE to perform the sensing task: select one or more UEs to perform the sensing task; transmit a sensing configuration to each of the one or more UEs; update a list of UEs that can be activated to perform the sensing task; or transmit a respective configuration to each UE in the list of UEs, wherein the respective configuration is applied to a corresponding UE in the list of UEs after the corresponding UE is activated to perform the sensing task.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a flow chart of exemplary procedure 600 for integrated sensing and communication in accordance with some embodiments of the present disclosure. Details described in all of the foregoing embodiments of the present disclosure are applicable for the embodiments shown in FIG. 6. In some examples, the procedure may be performed by a UE (e.g., sensing UE or alternate UE).

Referring to FIG. 6, in operation 611, a UE may receive, from a network node, a configuration associated with a sensing task. In some embodiments, the configuration may be applied to the UE to perform the sensing task after an activation of the UE. For example, the UE may be an alternate UE. In some embodiments, the configuration may be associated with a condition for triggering an activation of another UE to perform the sensing task. For example, the UE may be a sensing UE. In operation 613, the UE may transmit, to the network node, a measurement report based on the configuration.

The communications between the UE and the network node may go through a BS. In some examples, the communications may be a transparent transmission. For example, the BS simply passes through the signaling or data from the network node/UE to the UE/network node without changing, parsing or decoding the signaling or data. In some other examples, the communications may not be a transparent transmission.

In some embodiments of the present disclosure, the UE may transmit assistance data to a BS (i.e., the serving BS) in response to the condition being satisfied.

In some embodiments of the present disclosure, the aforementioned condition may include at least one of the following: a quality of a signal received by the UE being lower than a threshold during a time window; or the UE is leaving or leaves a target area associated with the sensing task. In some embodiments, the configuration associated with the condition may include the threshold.

In some embodiments of the present disclosure, the assistance data may indicate a measurement failure at the UE or that the UE is leaving or leaves a target area associated with the sensing task.

In some embodiments of the present disclosure, the UE may receive a deactivation message from the BS in response to transmitting the assistance data. The deactivation message may be received via lower layer (e.g., L1 or L2) signaling or high layer (e.g., RRC) signaling.

In some embodiments of the present disclosure, the configuration applied to the UE after the activation of the UE may indicate at least one of the following: whether the UE acts as a transmitting or receiving node; a sensing mode of the UE; a sensing period of the UE; or radio resources for the UE to perform the sensing task.

It should be appreciated by persons skilled in the art that the sequence of the operations in exemplary procedure 600 may be changed and some of the operations in exemplary procedure 600 may be eliminated or modified, without departing from the spirit and scope of the disclosure.

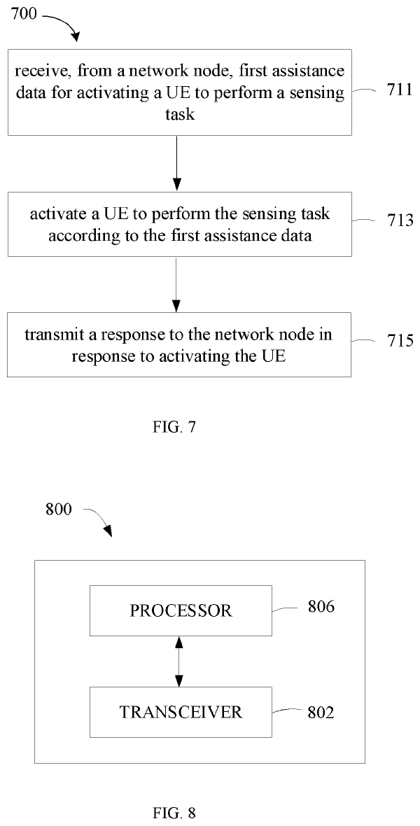

FIG. 7 illustrates a flow chart of exemplary procedure 700 for integrated sensing and communication in accordance with some embodiments of the present disclosure. Details described in all of the foregoing embodiments of the present disclosure are applicable for the embodiments shown in FIG. 7. In some examples, the procedure may be performed by a BS.

Referring to FIG. 7, in operation 711, a BS may receive, from a network node, assistance data (denoted as “first assistance data” for clarity) for activating a UE to perform a sensing task.

In operation 713, the BS may activate a UE to perform the sensing task according to the first assistance data. In operation 715, the BS may transmit a response to the network node in response to activating the UE.

In some embodiments of the present disclosure, the first assistance data may include at least one of the following: a threshold of receiving signal quality; an expected UE mobility state; a QoS requirement associated with the sensing task; or a list of UEs (e.g., a list of alternate UEs) that can be activated to perform the sensing task. The first assistance data may assist the BS to select UEs (e.g., to select alternate UEs to be activated) to perform the sensing task.

For example, the threshold may be used by the BS to select UEs (e.g., alternate UEs) in the coverage of the BS. When the receiving signal quality between the BS and a UE is greater than or equal to the threshold, the UE can be selected. For example, the expected UE mobility state may include expected UE speed, location information or both. For example, a UE (e.g., an alternate UE) with a relatively low speed and close enough to the sensing area can be selected. For example, the QoS requirement refers to the QoS requirement of the expected sensing service for the BS to conduct the necessary radio resources.

In some embodiments of the present disclosure, the BS may perform at least one of the following: receiving, from the network node, a request indicating the BS to activate at least one UE to perform the sensing task or to deactivate one or more UEs which perform the sensing task; receiving, from the network node, a configuration associated with a condition for triggering an activation of a UE; or receiving, from another UE (e.g., a sensing UE), assistance data (denoted as “second assistance data” for clarity) for triggering an activation of a UE.

In some embodiments of the present disclosure, activating a UE to perform the sensing task may include in response to receiving the request, or in response to the condition being satisfied, or in response to receiving the second assistance data: determining a UE to be activated based on at least one of a quality of a link between the BS and the UE to be activated or a mobility state of the UE to be activated; and transmitting an activation message to the determined UE. The activation message may be transmitted via lower layer (e.g., L1 or L2) signaling or high layer (e.g., RRC) signaling.

In some embodiments of the present disclosure, the BS may perform at least one of the following: in response to receiving the request, transmitting a deactivation message to the one or more UEs; in response to the condition being satisfied, transmitting a deactivation message to a UE associated with the condition being satisfied; or in response to receiving the second assistance data, transmitting a deactivation message to the another UE. The deactivation message may be transmitted via lower layer (e.g., L1 or L2) signaling or high layer (e.g., RRC) signaling.

In some embodiments of the present disclosure, the response may include at least one of the following: information of activated UEs; information of deactivated UEs; an indication of no available UE to be activated; information of candidate UEs to perform the sensing task; or a request for selecting a UE to perform the sensing task.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of exemplary apparatus 800 according to some embodiments of the present disclosure. As shown in FIG. 8, the apparatus 800 may include at least one processor 806 and at least one transceiver 802 coupled to the processor 806. The apparatus 800 may be a UE, a BS, or a network node (e.g., an AMF, an SF, or an LMF).

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a BS. The transceiver 802 and the processor 806 may interact with each other so as to perform the operations with respect to the BS described in FIGS. 1-7. In some embodiments of the present application, the apparatus 800 may be a network node. The transceiver 802 and the processor 806 may interact with each other so as to perform the operations with respect to the network node described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UE as described above. For example, the computer-executable instructions, when executed, cause the processor 806 interacting with transceiver 802 to perform the operations with respect to the UE described in FIGS. 1-7.

In some embodiments of the present disclosure, the non-transitory computer-readable medium may have stored thereon computer-executable instructions to cause the processor 806 to implement the method with respect to the BS as described above. For example, the computer-executable instructions, when executed, cause the processor 806 interacting with transceiver 802 to perform the operations with respect to the BS described in FIGS. 1-7.

In some embodiments of the present disclosure, the non-transitory computer-readable medium may have stored thereon computer-executable instructions to cause the processor 806 to implement the method with respect to the network node as described above. For example, the computer-executable instructions, when executed, cause the processor 806 interacting with transceiver 802 to perform the operations with respect to the network node described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A network node, comprising:
at least one memory; and
at least one processor coupled with the at least one memory and configured to cause the network node to:
transmit, via a base station-(BS), a first configuration associated with a sensing task to a first user equipment (UE) and a second configuration associated with the sensing task to a second UE, wherein the first configuration comprises a sensing configuration for the first UE to perform the sensing task, and the second configuration is applied to the second UE after the second UE is activated to perform the sensing task;
receive, from the first UE, a first measurement report based on the first configuration; and
receive, from the second UE, a second measurement report based on the second configuration after the second UE is activated.

2. The network node of claim 1, wherein the second configuration indicates at least one of the following:
whether the second UE acts as a transmitting or receiving node;
a sensing mode of the second UE;
a sensing period of the second UE; or
radio resources for the second UE to perform the sensing task.

3. The network node of claim 1, wherein the second configuration is transmitted to the second UE via dedicated signaling or system information (SI) broadcast.

4. The network node of claim 1, wherein the at least one processor is further configured to cause the network node to perform at least one of the following:
transmit, to the first UE, a third configuration associated with a first condition for triggering an activation of the second UE; or
transmit, to the base station, a fourth configuration associated with a second condition for triggering an activation of the second UE.

5. The network node of claim 4, wherein the at least one processor is further configured to cause the network node to receive, from the base station, a response in response to a request or in response to the third or fourth configuration, and the response comprises at least one of the following:
information of activated UEs;
information of deactivated UEs;
an indication of no available UE to be activated;
information of candidate UEs to perform the sensing task; or
a request for selecting a UE to perform the sensing task.

6. The network node of claim 5, wherein the at least one processor is configured to cause the network node to perform at least one of the following in response to receiving the request for selecting a UE to perform the sensing task:
select one or more UEs to perform the sensing task;
transmit a sensing configuration to each of the one or more UEs;
update a list of UEs that can be activated to perform the sensing task; or
transmit a respective configuration to each UE in the list of UEs, wherein the respective configuration is applied to a corresponding UE in the list of UEs after the corresponding UE is activated to perform the sensing task.

7. A user equipment (UE), comprising:
at least one memory; and
at least one processor coupled with the at least one memory and configured to cause the UE to:
receive, from a network node, a configuration associated with a sensing task, wherein the configuration is applied to the UE to perform the sensing task after an activation of the UE, or wherein the configuration is associated with a condition for triggering an activation of another UE to perform the sensing task; and
transmit, to the network node, a measurement report based on the configuration.

8. The UE of claim 7, wherein the at least one processor is configured to cause the UE to transmit assistance data to a base station in response to the condition being satisfied.

9. The UE of claim 8, wherein the condition comprises at least one of the following:
a quality of a signal received by the UE being lower than a threshold during a time window; or
the UE is leaving or leaves a target area associated with the sensing task.

10. The UE of claim 8, wherein the at least one processor is configured to cause the UE to receive a deactivation message from the base station in response to transmitting the assistance data.

11. A base station, comprising:
at least one memory; and
at least one processor coupled with the at least one memory and configured to cause the base station to:
receive, from a network node, first assistance data for activating a user equipment (UE) to perform a sensing task;
activate a UE to perform the sensing task according to the first assistance data; and
transmit a response to the network node in response to activating the UE.

12. The base station of claim 11, wherein the first assistance data comprises at least one of the following:
a threshold of receiving signal quality;
an expected UE mobility state;
a quality-of-service (QoS) requirement associated with the sensing task; or
a list of UEs that can be activated to perform the sensing task.

13. The base station of claim 11, wherein the at least one processor is configured to cause the base station to perform at least one of the following:
receiving, from the network node, a request indicating the base station to activate at least one UE to perform the sensing task or to deactivate one or more UEs which perform the sensing task;
receiving, from the network node, a configuration associated with a condition for triggering an activation of a UE; or
receiving, from another UE, second assistance data for triggering an activation of a UE.

14. The base station of claim 13, wherein activating a UE to perform the sensing task comprises in response to receiving the request, or in response to the condition being satisfied, or in response to receiving the second assistance data:
determining a UE to be activated based on at least one of a quality of a link between the base station and the UE to be activated or a mobility state of the UE to be activated; and
transmitting an activation message to the determined UE.

15. The base station of claim 13, wherein the at least one processor is further configured to cause the base station to perform at least one of the following:
in response to receiving the request, transmitting a deactivation message to the one or more UEs;
in response to the condition being satisfied, transmitting a deactivation message to a UE associated with the condition being satisfied; or
in response to receiving the second assistance data, transmitting a deactivation message to the another UE.

16. The base station of claim 13, wherein the condition comprises a quality of a signal received by the base station being lower than a threshold during a time window.

17. A processor for wireless communication, comprising:
at least one controller coupled with at least one memory and configured to cause the processor to:
receive, from a network node, a configuration associated with a sensing task, wherein the configuration is applied to the processor to perform the sensing task after an activation of the processor, or wherein the configuration is associated with a condition for triggering an activation of another processor to perform the sensing task; and
transmit, to the network node, a measurement report based on the configuration.

18. The processor of claim 17, wherein the at least one controller is configured to cause the processor to transmit assistance data to a base station in response to the condition being satisfied.

19. The processor of claim 18, wherein the condition comprises at least one of the following:
a quality of a signal received by the processor being lower than a threshold during a time window; or
the processor is leaving or leaves a target area associated with the sensing task.

20. The processor of claim 18, wherein the at least one controller is configured to cause the processor to receive a deactivation message from the base station in response to transmitting the assistance data.
